(19) United States
(12) Patent Application Publication
(10) Pub. No.: US 2018/0073260 A1
(43) Pub. Date: Mar. 15, 2018

(54) Hardscape stringline holder

(71) Applicant: Robert Middleton, Buod Lake, NJ (US)

(72) Inventor: Robert Middleton, Buod Lake, NJ (US)

(21) Appl. No.: 15/264,297

(22) Filed: Sep. 13, 2016

(51) Int. Cl. E04G 21/18; E01C 23/01; F16M 13/00

(52) U.S. Cl. CPC E04G 21/1833; F16M 13/00; E01C 23/01

(57) ABSTRACT

This invention is specifically designed to aid in installation of hardscape products using multiple levels of base materials, including, but not limited to flatwork, asphalt, foundation work, stairs, and concrete pavers or wallstone. The interlocking pavement institute has set specific guidelines for installation of said pavers and NCMA has guidelines for wallstone installation, both which include multiple base materials. Although other tools have been designed for stringline applications, none of them work properly in multiple level applications or have the advantages of saving substantial amounts of time on the jobsite. Previous versions need to be reset for each level of material being added or require multiples of the apparatus. This invention avoids the need to reset collar heights several times throughout the project and increases accuracy for each elevation needed. For this version string lines are held in grooves precut into the sleeve at each different elevation specific to the product thickness and installation requirements specified by the manufacturer of the product, or general normal installation methods. The most important aspect of our version is that only the stringline is moved, and not the holder. The holder stays in a fixed position and the line is moved to each corresponding level needed. The sleeves are used with holding bolts to secure the stringline onto grade stakes. For example: Our system uses a minimum of a three groove sleeve matching specific elevations such as required by the ICPI and NCMA which eliminates the need to reset the collars over and over again to obtain the proper elevation for each level of materials to be installed. An infinite number of grooves can be placed into the sleeves to accommodate any project. Some version may even have fully adjustable grooves on the sleeves to accommodate any custom multi-level project.

### BACKGROUND OF THE INVENTION

Correct materials placement is critical in construction applications. Projects such as paver patios, asphalt driveways, concrete sidewalks, or segmented retaining walls require multiple levels of base materials placed at specific levels and thicknesses. In projects requiring steps or multi levels the base materials must be placed repeatedly accurately and efficiently. A stringline is often used to aid in this construction for both final elevations and sub base levels.

Prior systems of stringline holders have addressed the need for a line to be held at a specific elevation. The shortcomings of the prior systems have required the use of multiple line holders or the constant re-measuring and adjusting for each and every level in multi-level project. When using a string line measuring device the starting point is often the finished level. If subsequent levels are required the system will need to be moved to a lower elevation to find the next level of base material to be installed. This is repeated for as many levels as required for a given installation. Unfortunately, unless two or more stringline holding units are used, the original elevation is then lost. By moving the stringline holder over and over again accuracy is also difficult to maintain, and repeatability is complicated or slow with the constant need to refigure the elevations and measure from a starting point.

In addition, previous versions failed in the ability to be easily create secondary levels for installation including something similar to a staircase by simply placing one sleeve on top of the next. Previous versions required more measuring, and calculating where to place the second device.

The most significant difference between our system and previous systems is that the sleeve or stringline holder is not moved once it is set on the project. Only the stringline is moved from level to level to the different grooves on the sleeve to adjust for different elevations corresponding to each level of material to be installed.

Previous inventions such as U.S. Pat. No. 6,421,923 b1 are specifically designed as a two groove collar. Although it has the ability to hold a string line accurately at a given elevation, it is very difficult to use in a multi material installation project. It requires constant measuring and relocating the elevation on the pin, stake, or rod to obtain each individual elevation required or requires multiple collars on each stake.

Previous versions also required the laborers to understand exactly what each level needed to be set at. Our version only requires the finished grade to be set and then the laborers can move the stringline to each subsequent level with greater accuracy and efficiently than using a measuring device. New laborers to the industry can move the stringline to subsequent levels as accurately as a laborer that has been doing the work for years.

### SLEEVES PATENT SUMMARY OF INVENTION

It is the object of the present invention and in accordance with the illustrative embodiments demonstrating features and advantages of the present invention, there is provided a method of employing a stringline holding device with multiple levels of use.

It is the object of the present invention to increase usefulness and productivity prior stringline systems failed to incorporate into the design

It is the object of the present invention to simplify the method of adjusting a stringline on projects requiring multiple levels.

It is the object of the present invention to remove the need to physically adjust the stringline holder each time a new stringline elevation is needed in multiple level projects.

It is also the object of the invention to improve the accuracy of each level the stringline is needed at in multiple level projects without the need for constant re-measuring and relocation of the stringline holder.

It is also the object of the invention to simplify layout for each layer needed during construction or excavation without having to readjust the stringline holder.

It is the object of the invention to create a stackable system for doing multiple levels each containing multiple layers within each level.

It is the object of the invention to save significant time on the jobsite by not requiring constant measuring and relocating of the stringline holder

It is the object of the invention to simplify elevations so that employees of any experience level can perform the task of relocating the lines accurately for each level.

It is the object of the invention to improve significantly on prior versions of stringline holders and the methods of use.

It is the object of the invention to provide an accurate method of measuring grades and elevations by providing a surface from which to measure from.

It is also the object of the invention to provide an accurate method to determine subsequent grades at each level easily without relocating the stringline holder.

It is the object of the invention to hold the stringline securely at each grade level required without relocating the string line holder and creating inaccuracy.

### BRIEF DESCRIPTION OF THE DRAWINGS

FIG. 1. is a basic view of the invention as described

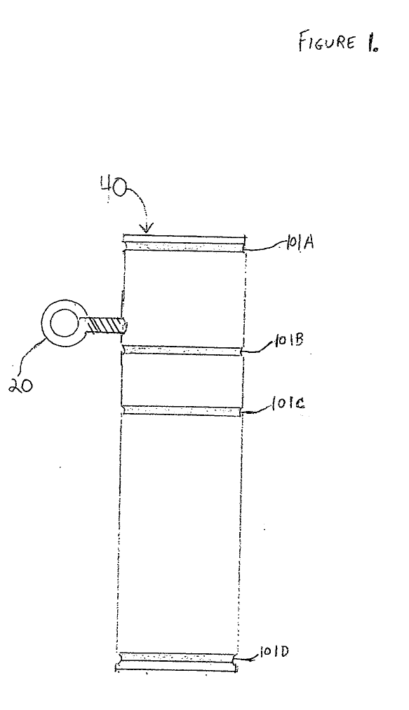

FIG. 2. is a view of the invention using a grade stake to hold it into an excavated grade with a stringline attached.

FIG. 3. shows a side view of the invention.

FIG. 4. Shows a level and beam resting on edges of invention for purposes of setting the grades to proper level

FIG. 5. Shows how the sleeves grooves and using a stringline relate to the installation with pitch and elevation changes.

FIG. 6. Shows how the installed materials match the gradations of the sleeves.

FIG. 7. Illustrates the relation between the sleeves, stringline, and materials to be installed.

FIG. 8. Shows an equal multi graduated sleeve and how a stringline can be placed as needed to create custom pitches or levels.

FIG. 9. Shows equal multi graduated sleeves installed on a grade level to each other. It also shows how moving the stringline from one level to next creates pitch over distance.

FIG. 10. Is showing the sleeves being used in a step application with two different collars stacked.

FIG. 11. Is prior art showing similarities and differences between two inventions.

### DRAWINGS

### Reference Numerals

14A Equally divided sleeve with multiple graduations
14c specific measurement for a stackable sleeve
14d Specific measurement for a base sleeve
20 Tensioner/hold down eyebolt
30 Inner opening
40 Sleeve (not specific)
50 Stringline
60 Grade stake
80 Grade or excavation limit
90 Step construction sleeve (base or bottom)
100 Step construction sleeve stackable (top)
101 (a,b,c,d, etc) Groove location
110 (a,b,c,d, etc) Materials location
140 Level
160 Beam or board
180 Stair or wall block

### DETAILED DESCRIPTION OF THE DRAWINGS

Referring to Figure one. Shows basic Sleeve 40 configuration of a typical 4 groove sleeve 101a,101b,1011c,101d. Sleeve has multiple grooves to accommodate stringline at different elevations specific to the project at hand. The eye screw holds the sleeve onto a grade stake. The eyescrew 20 also duplicates as a secondary line tie off point and a storage point in which to tie or hang the unit when it is not in use. The sleeve has a specific top and bottom which correlates to the products being installed.

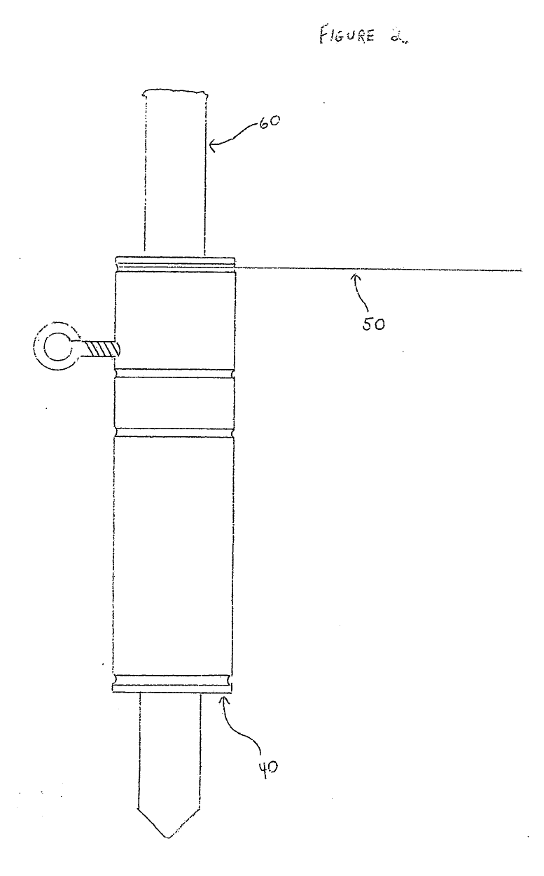

FIG. 2. shows a four groove sleeve 40 mounted on a grade stake 60 with a stringline 50 supported by the grooves on the sleeve 40.

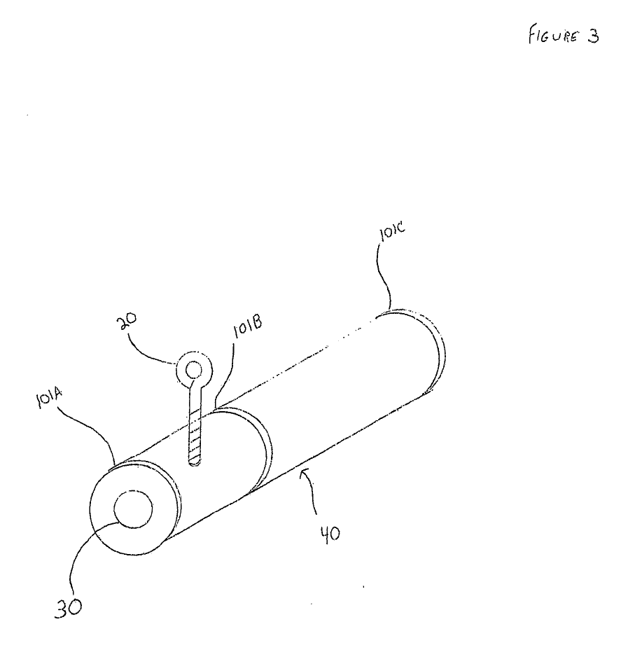

FIG. 3. Is a detailed side view of sleeve 40 showing each of the individual grooves of this particular sleeve representation. 101a,101b,101c are grooves cut into the sleeve for reference of the stringline in relation to the materials being installed. An eyebolt 20 is the hold down method that secures the device to a grade stake or rod, not shown that passes through the sleeve at point 30.

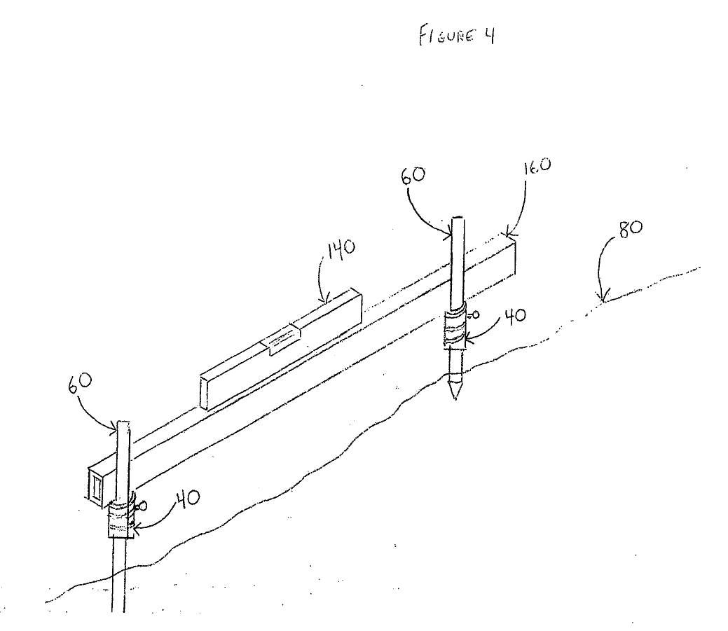

FIG. 4 indicates how using multiple sleeves 40 can simplify layout of a project. The sleeves can easily be raised or lowered on the grade stakes 60. Using a level 140 and, or a beam 160 across the sleeves 40 allows for a rigid surface to accurately create the correct pitch in relation to the level or grade 80. A transit may also be used, or any traditional elevation measuring device.

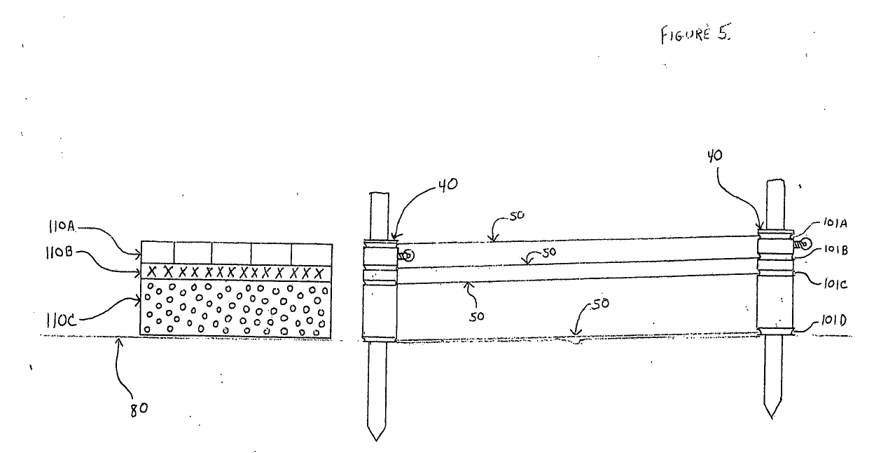

FIG. 5. Shows two sleeves 40 being used on a pitched project with stringlines 50 at each of the multiple levels of materials to be installed 110a,110b,110c. The excavation limit is also shown 101d on the collar which corresponds to the excavated grade 80. Each level of material to be installed 110a,110b, 110c is shown at different thicknesses corresponding to the stringline grooves 101a,101b,101c on sleeve 40.

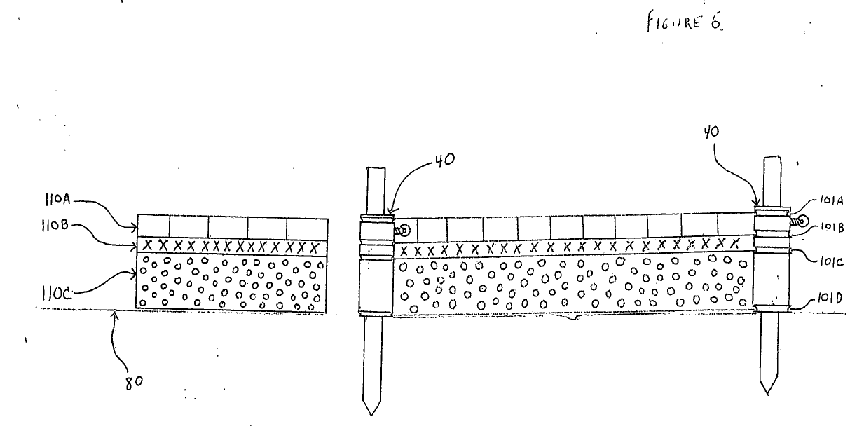

FIG. 6. Shows each material installed 110a,110b,110,c and the correlation to grooves 101a, 101b, 101c. on sleeve 40. It shows the material built on top of excavation 80 or groove 101d on each level of sleeve 40 following the elevations and slopes set.

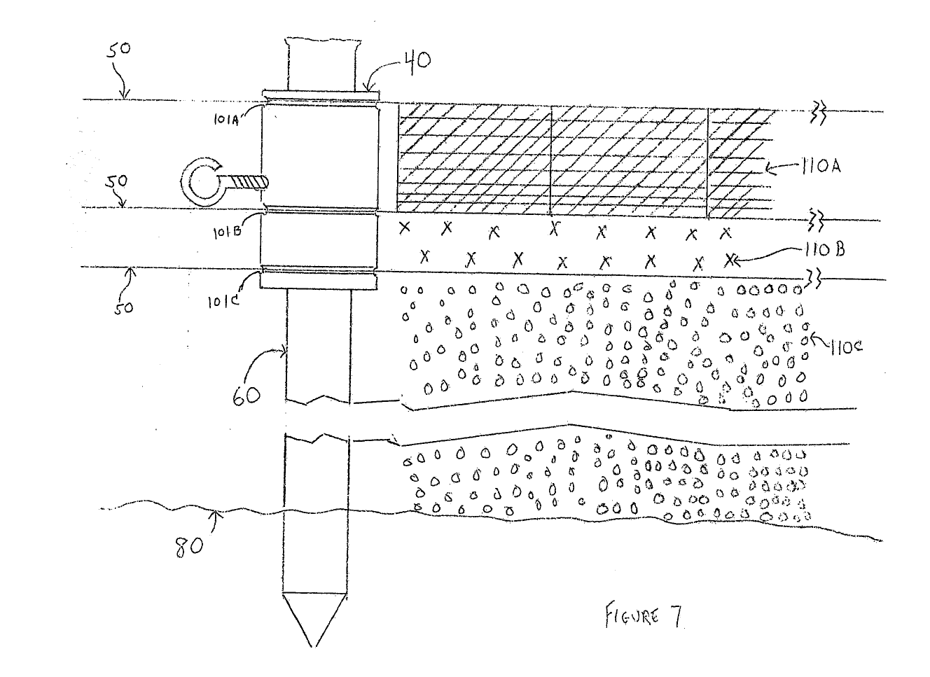

FIG. 7. shows a three groove sleeve 40 and how the grooves are referenced in relation to the product being installed 110a,110b,110c. The stringline 50 grooves 101a,101b,101c correlate to each material level needed for installation.

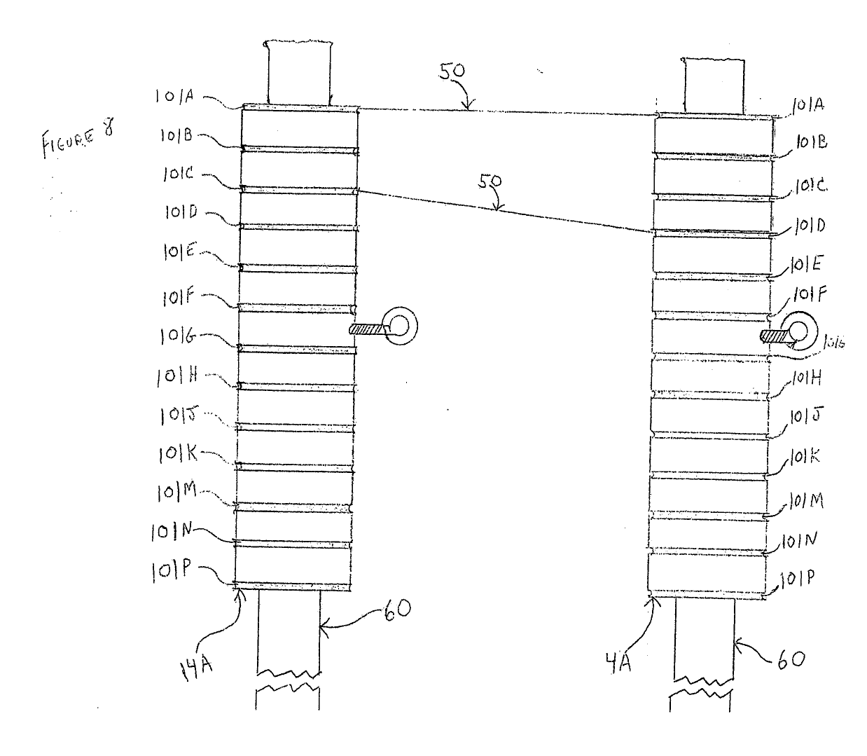

FIG. 8. is an example of equally divided sleeves 14a with multiple levels 101a,101b,101c,101d,1011e,1011f,1011g,1011h,1011j,1011k,101m,101n,101p mounted on grade stakes 60 set level with stringlines 50 showing how the line 50 can be set level using grooves 101a to 101a between two or more sleeves, or pitch can be created using grooves 101c and 101d between two or more sleeves 14a.

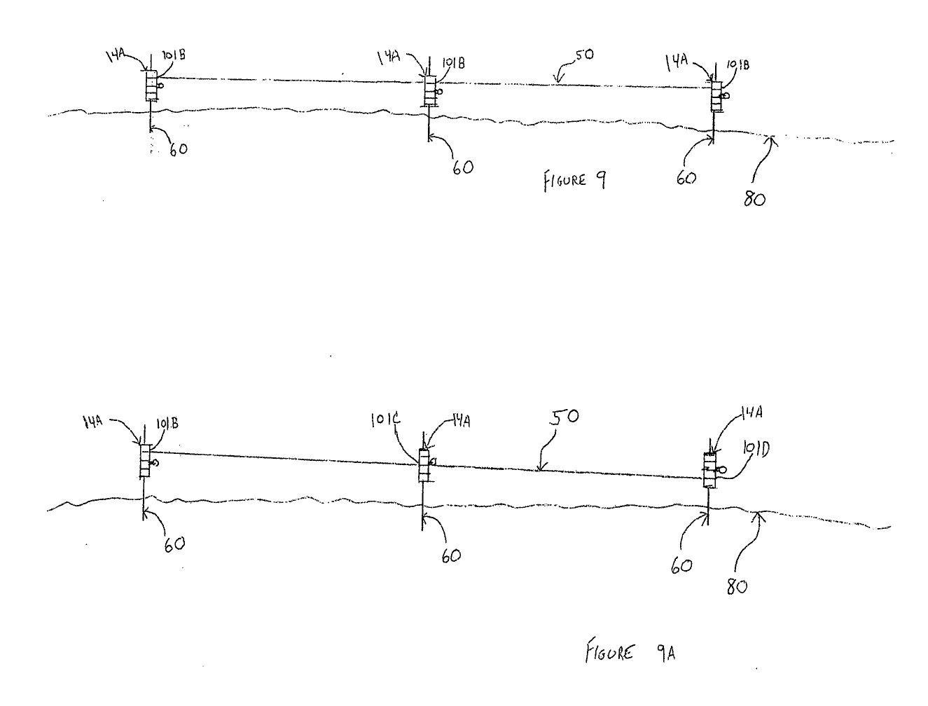

FIG. 9. Shows 3 multiple level equally graduated sleeves 14a set on a grade 80 over distance. Each of the sleeves tops 14a are leveled using a transit or level. With the stringline 50 run between each sleeve 14a mounted on grade stake 60 at level 101b the line remains level between each point.

FIG. 9a. With each of the 3 sleeve's tops 14a mounted on grade stakes 60 set level moving the stringline 50 from locations 101b to 101c on the second stake 60 and 101b to 101d on the third stake 60 creates pitch and elevation changes. The variations are unlimited and any amount of pitch or grade change can be achieved using appropriate sized sleeves 14a with correct gradations.

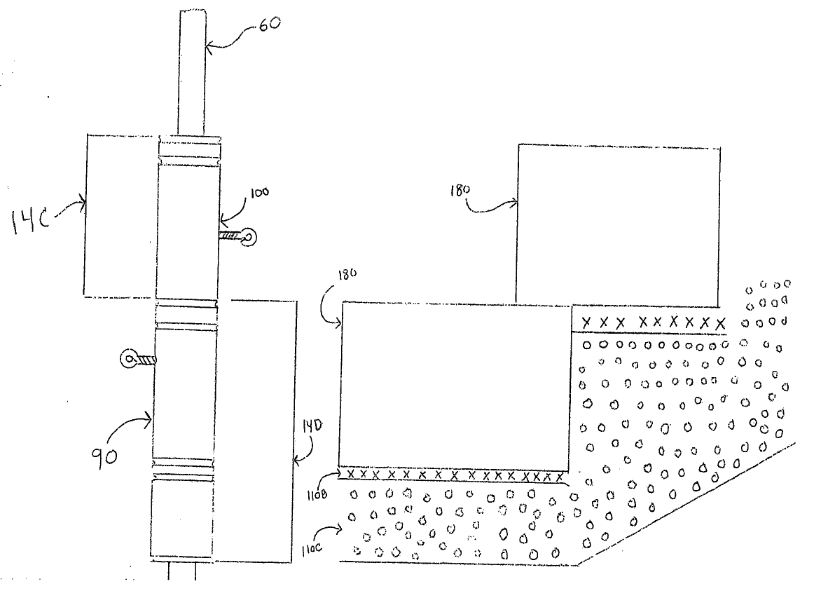

FIG. 10. Is showing how two stacked sleeves 90, 100 of predetermined lengths can be used to build a complex project such as block steps 180. A grade stake 60 is set with a single sleeve 90 including excavation and subbase materials indicator grooves Sleeve 90 is a base sleeve with a predetermined elevation specific to the bottom course 14d. This sleeve 90, may also have indicators for next level. A second sleeve 100, is then stacked on top with predetermined elevation 14c and grooves. Subsequent levels can continue to be added simply be stacking more sleeves 100 at the 14c dimensions over the grade stake 60.

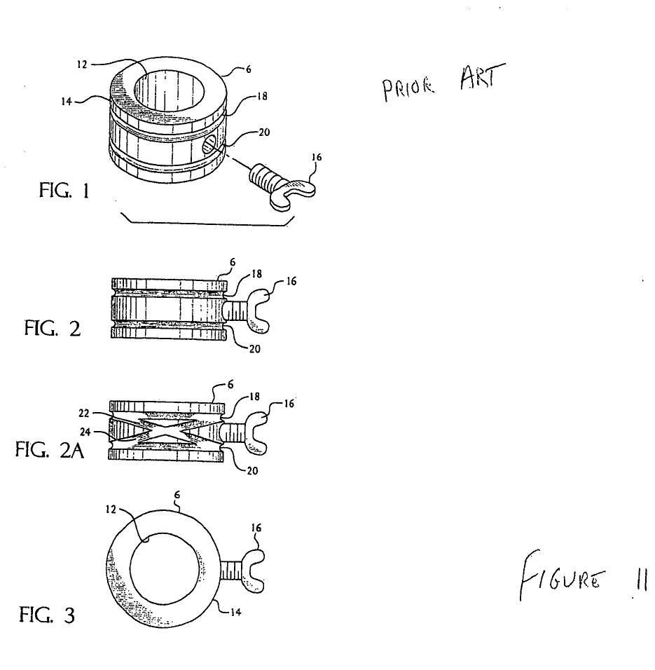

FIG. 11 is prior art. It is referenced to show similarities and differences between the two systems. The collar presented in FIG. 11 needs to be moved for each level of material to be installed. It is specifically claimed to be a two groove collar has no designated references to specific elevations or material requirements.

1. A stringline holder, comprising:
(a) A device with a minimum of three grooves holding a stringline at specific elevations needed in multiple material projects, with
(b) a specific top and bottom of the device corresponding to the grooves, and
(c) the grooves shall provide positioning for the stringline so that the main body of the stringline holder does not need to be repositioned once it is set up to obtain the multiple levels required.

2. A sleeve with precut specific distanced grooves,
(a) and be a minimum of 1.5″ long, with
(b) a central inner surface ¾″ minimum, and
(c) specified distances between grooves corresponding to specific materials and installations as needed.

3. A stringline holder as in claim 1 consists of a sleeve of specific manufactured size to match the product to be installed and multiple levels of materials needed.
(a) A sleeve means encircling any post, pin, marker or stake used in obtaining elevations, and
(b) has a device to hold the sleeve in place on the post, pin, marker, or stake, and
(c) consists of a surface of which to hold onto the post, pin, marker, or stake, and
(d) a surface with grooves to hold the stringline at each level as needed without resetting the sleeve for each position

4. A method of adjusting a stringline by moving the stringline only to each level and not moving the holding device.
(a) A sleeve provides a method of moving only the stringline to each groove, and not the entire mechanism to achieve all of the different elevations without having to reset and remeasure for each level.
(b) a series of grooves provides elevations specific to the project at hand and
(c) means of adjusting or resetting of the sleeve moves all primary and subsequent grooves automatically to the new perspective relative elevations without having to recalculate and remeasure for each.

5. (canceled)

6. (canceled)

7. (canceled)

8. (canceled)

9. (canceled)

10. (canceled)

11. (canceled)
